(19) United States
(12) Patent Application Publication
(10) Pub. No.: US 2005/0288987 A1
(43) Pub. Date: Dec. 29, 2005

(54) Vacation planning and approval

(75) Inventors: Juergen Sattler, Wiesloch (DE); Joachim Gaffga, Wiesloch (DE)

Correspondence Address: KENYON & KENYON, 1500 K STREET NW, SUITE 700, WASHINGTON, DC, 20005, US

(73) Assignee: SAP Aktiengesellschaft

(21) Appl. No.: 11/045,366

(22) Filed: Jan. 31, 2005

Related U.S. Application Data
(60) Provisional application No. 60/584,072, filed on Jun. 29, 2004.
(60) Provisional application No. 60/585,121, filed on Jul. 2, 2004.
(60) Provisional application No. 60/623,875, filed on Nov. 2, 2004.

(51) Int. Cl. G06Q 10/00

(52) U.S. Cl. 705/9

(57) ABSTRACT

A method for scheduling and approval of vacation requests providing conflict identification and resolution. When a manager considers a vacation request from an employee, conflict information and scheduling alternatives are presented to facilitate decision making. Information regarding other personnel working with the employee on projects is also presented. The employee also receives additional planning information.

### RELATED APPLICATIONS

Priority is claimed from U.S. Provisional Application Nos. 60/584,072 filed Jun. 29, 2004, 60/585,121 filed Jul. 2, 2004, and 60/623,875 filed Nov. 2, 2004, the contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Software systems for planning and approving personnel vacations within an organization.

### BACKGROUND

Existing software-based implementations for planning and approving employee vacations are extensions of pre-computer systems, offering basic booking and confirmation processes. In essence, managers approve or disapprove vacation requests on a first-come-first-serve basis. The computer serves as messenger (e.g., e-mail) and record keeper (e.g., management-maintained spreadsheets), but existing tools offer little in the way of information transparency and collaboration.

In existing systems, personnel are left to acquire their own information to plan their vacations. For example, an employee may know how many days of vacation they have remaining in the year or may need to ask. Information regarding project deadlines is usually available only on a per-project basis and little may be known about the scheduling plans of other project personnel. While the employee is likely aware of events and appointments on his/her own calendar, finding scheduling alternatives can be time consuming.

The information available to a manager when deciding to approve the vacation is similarly limited. The projects in which the employee are involved and timelines of the projects are usually not transparent. Likewise, a manager may not recognize customer relationship management (CRM) activities planned during the requested vacation; nor know the employee's training schedule and appointments; nor know the schedules of other personnel involved in the employee's projects; nor know if substitute personnel are available for the duration of the requested vacation. While all of this information may be available to a manager, it is usually procured piecemeal, and is often out-dated before the decision to approve or decline the vacation request is even made.

This lack of transparency for both personnel and managers makes the handling of vacation requests time-consuming, leads to under-utilization or over-utilization of personnel, and increases the likelihood of discontent among employees whose vacation requests are denied. Given the importance of vacations to the psychological well-being and productivity of personnel, it would be preferable if the process of planning and approving the vacation request was more collaborative and less time consuming.

### BRIEF DESCRIPTION OF THE DRAWINGS

FIG. 1 is an example of a system implementing vacation planning and approval by way of computer terminals.

FIG. 2 illustrates an embodiment of the process as performed by a process engine to integrate and manage generation and approval of vacation requests.

FIG. 3 illustrates a process for querying a framework of systems in order to collect and collate data.

FIGS. 4A-4C illustrate an example of how conflict information may be displayed to a decision maker considering the merits of the vacation request, each figure showing certain portions of the information “collapsed” and certain portions “expanded” for viewing.

FIG. 5 illustrates an embodiment of the present invention for generating a vacation request.

FIG. 6 illustrates an example of how conflict information may be displayed to a person making a vacation request.

FIGS. 7A-7E are a flow chart illustrating an embodiment for processing a vacation request.

FIG. 8 is a flow chart illustrating an embodiment in which the vacation request is passed directly from the employee making the request to the manager(s) deciding whether to approve or decline.

FIG. 9 is an example of a system implementing vacation planning and approval by way of a voice connection.

### DETAILED DESCRIPTION

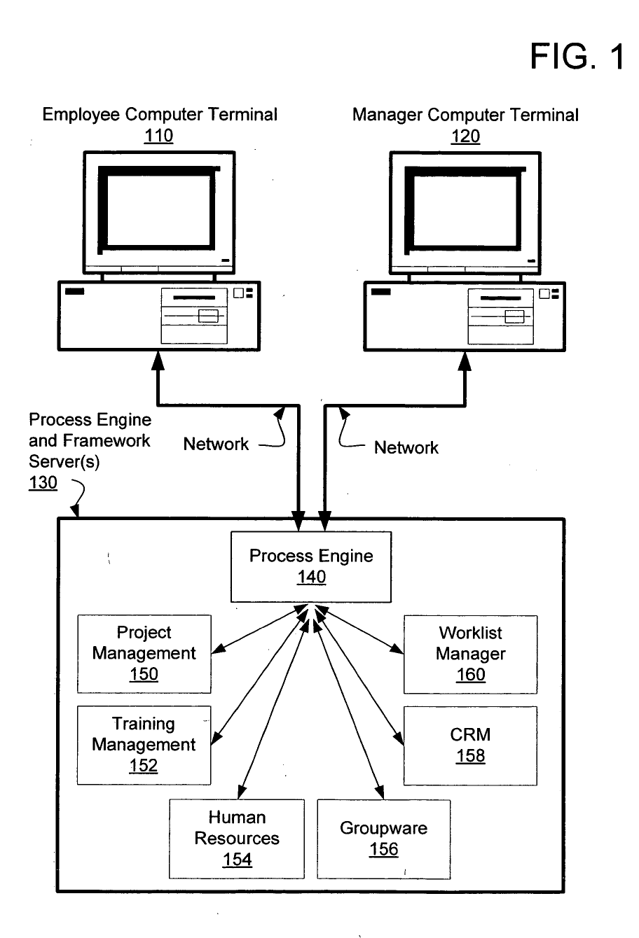

The present invention improves transparency and collaboration in the vacation planning process. Referring to FIG. 1, a process engine application (140) on a server or servers (130) seamlessly integrates information from across various systems for presentation at an employee terminal (110) to an employee wishing to request vacation and for presentation at a manager terminal (120) to a manager who may approve the request. Information is organized to simplify decision making, automatically identifying conflicts and alternatives.

The process engine application (140) draws information from a framework which may reside across several servers, subsystems, application programs, and database management systems (DBMS), referred to generically herein as “systems.” This framework may include a project management system (150), a training management system (152) (including external trainings), a human resources system (154), a groupware system (156) (e.g., Exchange Server from Microsoft®; Lotus Notes® server), customer relationship management (CRM) systems (158), and a worklist management system (160), as well as. In addition to integrating information, the process engine application (140) can update systems (e.g., groupware tasks and calendars; human resources records) to reflect changes made during the vacation planning and approval process.

In addition to managing information across the framework, the process engine (140) maximizes data security by serving as a buffer between user terminals (110, 120) and the framework systems. This avoids remote terminals directly querying sensitive systems such as those containing human resources data (154), thereby lowering the risk of improper intrusions.

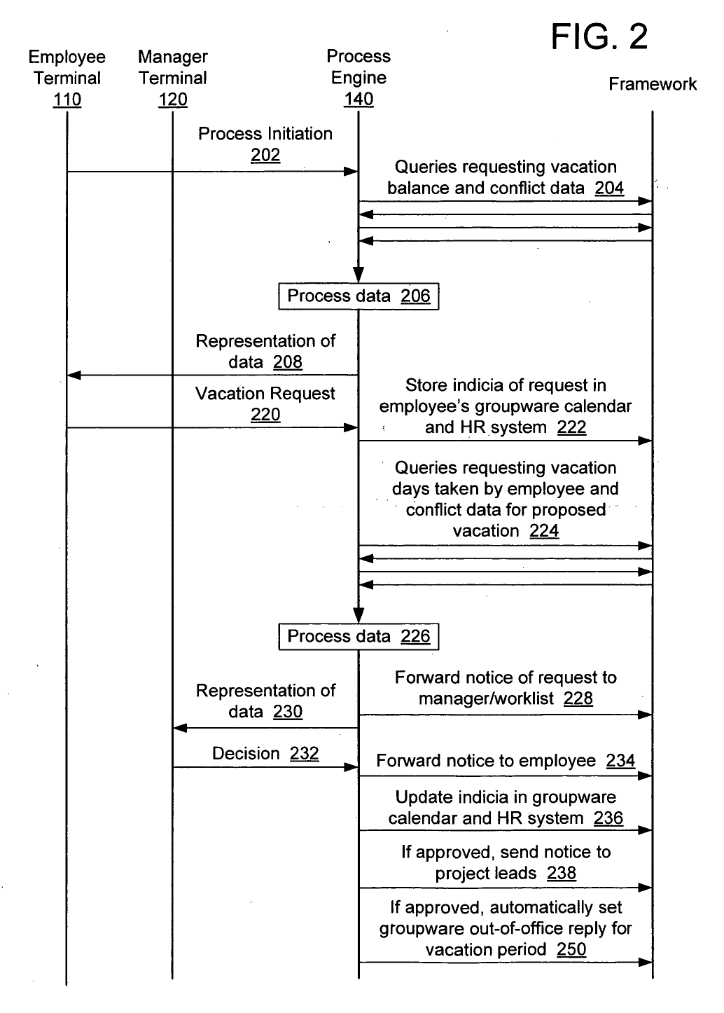

FIG. 2 illustrates an embodiment of the process performed by the process engine (140). An employee initiates (202) the process from the employee's terminal (110). In response, the process engine queries (204) the framework using an employee identifier to retrieve vacation balance and scheduling conflict data. The data is processed and integrated for presentation (206) and then sent (208) to the employee's terminal (110). After the employee submits a vacation request (220), the process engine stores (222) indicia of the vacation request in the groupware calendar of the employee on the groupware system (156). Other indicia that a request is pending may also be stored locally, or for example, in the human resources system (154).

After the vacation request is submitted (220), the process engine (140) may again query the framework (224) for information to be used in the decision making. The cumulative data is integrated and processed for presentation (226) to a manager.

A notice may be forwarded (228) to the manager indicating that the process request has been received. Forwarding may be, for example, by e-mail sent through the groupware system (156) or by a posting to a worklist through the worklist management system (160). The notice may indicate that the vacation request has been received, may include all or some of the information that the decision maker will use when deciding whether to approve the request, may include a link to a web or network location, may include a form including a script which will populate fields of the form, or may include a combination thereof.

The process engine (140) provides the manager with the integrated data (230), including information from the vacation request, a number of vacation days already taken by the employee, and information regarding potential conflicts with the employee's proposed vacation. The integrated data may also include, among other things, taken and open vacation days per employee in the organization or some subset of employees thereof. After a decision is received (232), the process engine forwards (234) notice of the decision to the employee, updates (236) the employee's groupware calendar, and updates where ever else a record of the pending request was stored (e.g., human resources system 154). If the vacation was approved, the process engine may send notice (238) of the vacation to leaders of projects to which the employee is assigned, based on projects associated with an employee identifier in the project management system (150). The process engine may also set (250) an automatic out-of-office e-mail reply for the employee on the groupware system (156), and may also can cancel all meetings for the employee in the time-frame of the vacation.

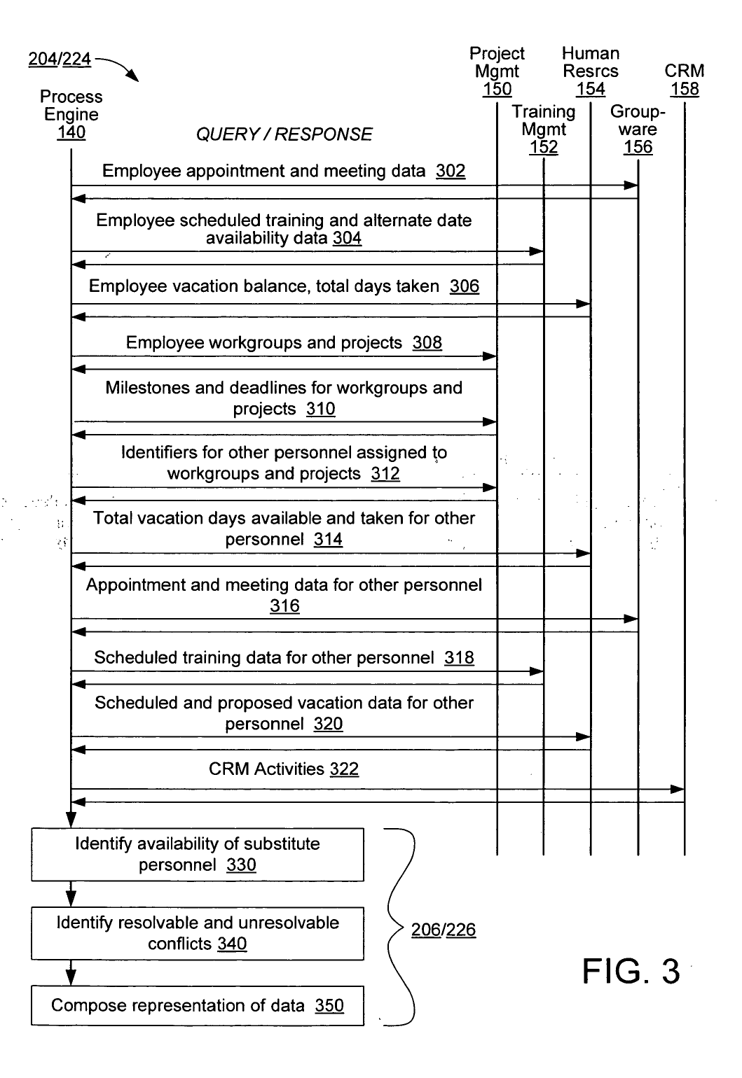

FIG. 3 illustrates an embodiment of the process for querying the framework (204, 224) and for the processing of the data (206, 226). Each of the querying (204, 224) and processing (206, 226) may include some or all of the illustrated data-acquisition queries and processes. If a data acquisition query or process is performed for vacation request preparation (204, 206), the data may be reused for decision making preparation (224, 226) or the query/process may be performed again. For example, to assure that the information is up-to-date when a decision is made, the process engine (140) may perform or repeat the query/process (224, 226) at the time the data is presented for the decision maker (230). Each of the illustrated queries may be a single query or plural queries.

The process engine (140) may send a query to the groupware system (156) for employee appointment and meeting data (302), such as data found in the employee's electronic calendar. A query may be sent to the training management system (152) for the dates of scheduled trainings in which the employee is enrolled, and for alternative dates for the scheduled trainings (304). A query may be sent to the human resources system (154) for the employee's vacation balance and the total number of vacation days taken (306). A query may be sent to the project management system (150) for the workgroups and projects associated with the employee's identifier (308). With the workgroups and projects identified, queries may be sent to the project management system (150) for milestones and deadlines for the workgroups and projects (310), and for the identifiers of other personnel assigned to the workgroups and projects (312). With the identifiers of the other personnel, queries may be sent to the human resources system (154) for the total vacation days available and taken by each of the personnel (314), to the groupware system (156) for the appointment and meeting data for each of the personnel, to the training management system (152) for the scheduled training data for each of the personnel (318), and to the human resources system (154) for scheduled and proposed vacation data for each of the personnel (320). A query may also be sent to the CRM system (158) to identify CRM activities planned during the requested vacation.

The process engine (140) identifies personnel that may be available to substitute for the employee if the vacation is approved (330). This may based on the data acquired for the personnel assigned to the same workgroups and projects as the employee, and may include additional queries to the framework to identify additional personnel (e.g., personnel specifically identified as unassigned or available).

The process engine also may identify resolvable and unresolvable conflict (340). What constitutes a “resolvable” versus an “unresolvable” conflict may be determined in several ways. The system may include a hierarchy for events and personnel involved in the events. For example, the designation making an event “resolvable” may based upon ranks of personnel within the organization scheduled to attend the event, or a rank of the employee at the event (e.g., presenter versus attendee). Some events may be pre-marked, tagged, or resolved as having “soft” dates (i.e., changeable) or “hard” dates (i.e., critical). Whether alternative dates for events such as training sessions are available may also be used in the determination.

Similarly, what events can be rescheduled by the manager or the employee and what events constitute “hard” date events may depend upon the nature of the event. For example, an employee would not be permitted to reschedule a colleague's vacation. However, an employee would ordinarily be able to reschedule their private appointments, and a group leader planning a vacation might be permitted to reschedule a milestone date.

Where alternative dates are available, overlapping conflicts may be considered. For example, if an alternative training time conflicts with another event on the employee's schedule, the alternative time can be identified, but may be flagged to highlight the conflict with the other event. However, if the employee or manager chooses to reschedule the “other event,” the conflict information may be updated to identify the alternative training time as open.

The process engine (140) prepares a representation of the data for presentation (350) to the employee and/or the manager. As an embodiment of the invention, the representation is a form or information organized to populate fields of a form. Examples of types of forms that can be used include interactive and web-based forms (e.g., forms comprising Hyper Text Markup Language (HTML), extensible Markup Language (XML), Java™, Visual Basic®, etc.), page description language forms allowing data entry (e.g., Adobe® Acrobat®), word-processing or database forms (e.g., Microsoft® Word®, Excel®, or Access® documents with entry fields), custom forms or form plug-ins to connectivity software (e.g., a form presented via a groupware client such as Microsoft® Outlook® or Lotus® Notes), or a form generated by a stand-alone application. A series of prompts generated by a script may also serve as the form or may be utilized to complete the form.

Features such as guided procedures and the rescheduling of conflicts may be implemented in conjunction with a larger software package, providing user interface integration with other scheduling tools and utilizing scripting and calendar features that are commonly available in such packages (e.g., a groupware client). The interactive form may include a script (e.g., Microsoft® document including Visual Basic® code or a document with embedded Java™ code) of executable instructions for guided procedures and rescheduling.

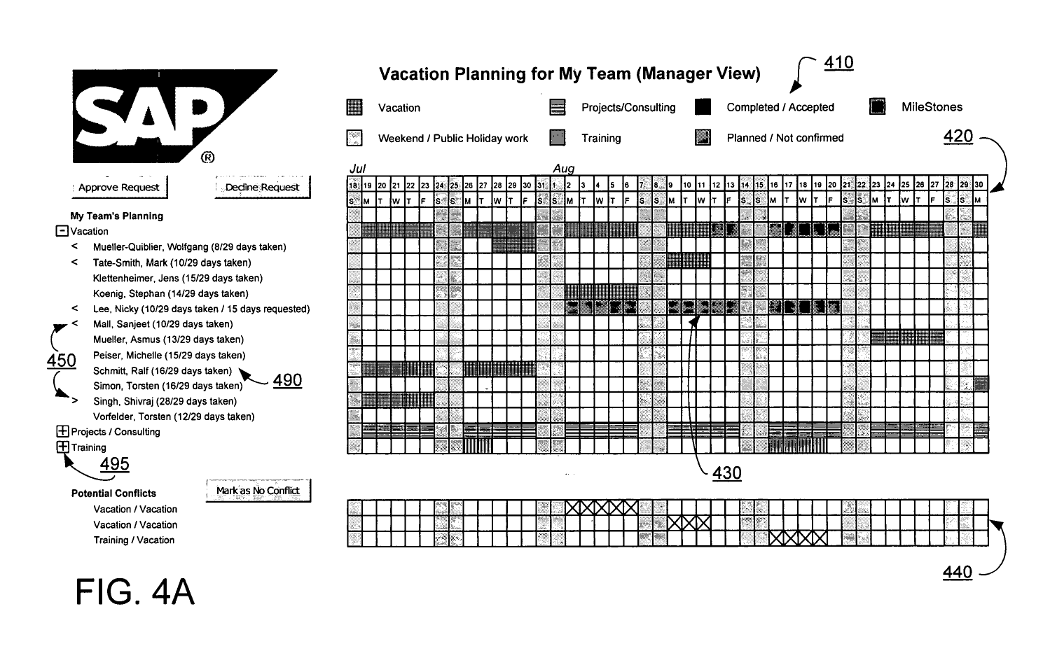

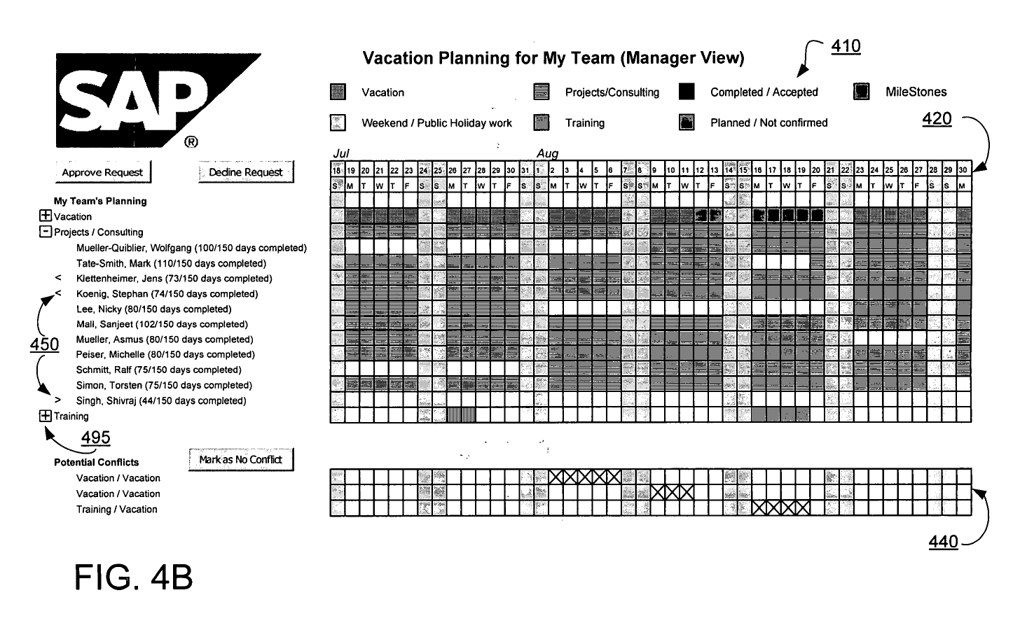

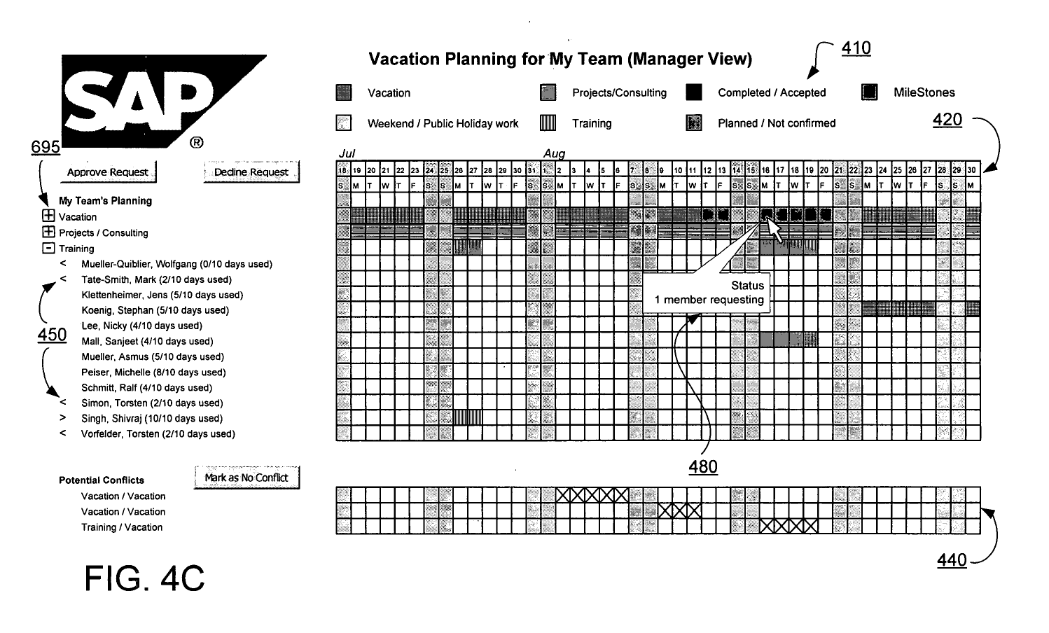

FIGS. 4A-4C are an example of the representation of data as presented to the manager. In this example, the data is formatted by the process engine (140) for Microsoft® Excel® in a calendar-style for easy visualization. FIG. 4A through FIG. 4C are a same example, with different portions of the information being expanded and collapsed between figures (i.e., “+” and “−” buttons 495).

The example representation includes a legend (410), a timeline (420), an indication of the vacation dates requested (430), and conflicts (440). Additional information about each entry can be determined by way of a or separate window or a pop-up (480) that appears when the entry is selected, or by providing a separate active display field/box which displays more information when the entry is selected. Selection of an entry may comprise passing a cursor or pointer over the entry, or by actual selection (e.g., a mouse “click” or key-stroke to select the entry).

Additional information may also be presented, such as the number of days taken and allocated to personnel (490). Personnel may be flagged to facilitate decision making. For example, if FIG. 4A, personnel are flagged (450) to highlight who has taken too few vacation days (“<”) and who has taken a high number of vacation days (“>”). Likewise, personnel who have taken little or no vacation days may be flagged. Similar notation is illustrated in FIGS. 4B and 4C to show progress on projects and attendance/enrollment at trainings. Color-coding or other notation may also be used.

As shown in the potential conflicts section (440), vacation/vacation conflicts may be individually displayed. As a further embodiment, this vacation/vacation conflict feature can also be used to simultaneously resolve vacation requests from multiple requesters. Training/vacation conflicts can also be broken out by person, if handling multiple requests.

The manager may be given the option of redesignating selected conflicts as not being conflicts. A “mark as no conflict” button is included in FIGS. 4A-4C as an example. The manager may also be given the option of rescheduling or canceling events which the employee is not authorized to change. In circumstances where plural persons (discussed below) must approve the request, the ability to redesignate conflicts can streamline the process, since one decision maker may be able to remedy a conflict for all decision makers.

As another example, by selecting an event or conflict, the manager may be provided a user interface to change times and dates. A “drag-and-drop” interface may be also be utilized within the timelines. As an embodiment, when event times and dates are changed via the user interface and submitted to the process engine (140), the event information is updated across the process engine's framework. Likewise, an “update” feature can be provided so that if time and date information is changed elsewhere, the displayed information is also updated.

The manager may also be provided the option of automated generation of rescheduling suggestions. The system can provide solutions for reordering events to accommodate the proposed vacation or to minimize conflicts using conventional search techniques, with or without heuristics. For example, the search may be based upon the hierarchy for events and personnel discussed above. If such suggestions do not present a workable arrangement, the manager may redesignate, move, or cancel selected events. Revised scheduling suggestions may be provided after the manager makes changes, taking into account the changes.

As a further feature, if the automated preparation of scheduling suggestions does not find an arrangement of conflicts that permits approval of the vacation, scheduling suggestions highlighting the fewest conflicts may instead be presented to the decision maker (e.g., a least-cost analysis is performed, presenting alternative schedules with the fewest remaining conflicts).

As a further example of the conflict resolution interface, times and dates may be changed by selecting an events and alternatives may be displayed for the user's consideration.

A further embodiment of the conflict resolution aspect of the invention includes guided procedures to handle rescheduling events such as appointments and trainings. For example, the user may be prompted to reschedule an appointment or choose from alternate training times. The prompts may be ordered to follow a particular pattern, such as handling events with the most rescheduling uncertainty first, and the most rescheduling certainty last (or vice versa). Likewise, the user may be prompted to specify the order in which conflicts will be resolved.

These guided procedure prompts can also be used with the automated generation of rescheduling suggestions. In particular, if no scheduling solution is found, the search results having the least-cost (e.g., fewest remaining conflicts) may be basis for a series of guided procedure prompts. For example, if the proposed vacation would avoid conflicts if a training is moved, but the alternate training times conflict with existing appointments, the user may be prompted to choose which appointment(s) to move.

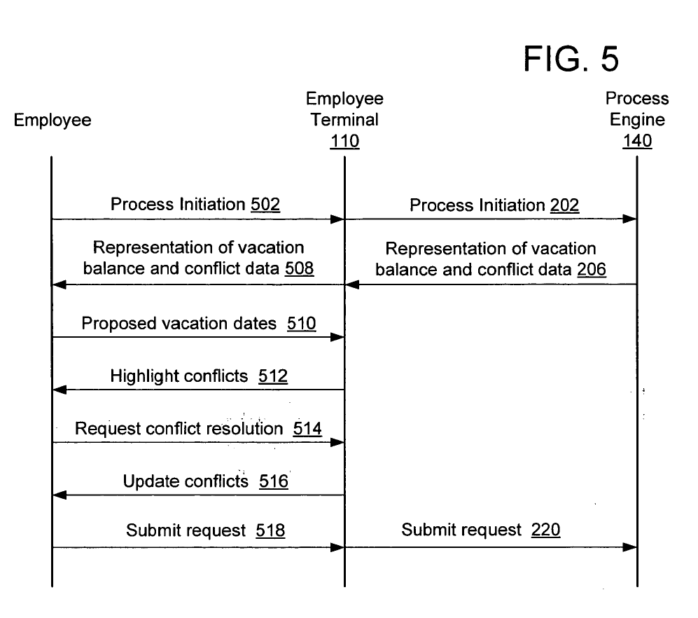

FIG. 5 illustrates an embodiment of the present invention for generating a vacation request. After the process is initiated by the employee (502/202), the process engine (140) provides vacation balance information (e.g., days allotted for year and days already taken) and a representation of conflict data (206).

Several techniques may be used to initiate the process acquire the employee's vacation balance. For example, a form may be called-up on the employee's terminal (110). The form may contain an active embedded script that automatically requests and receives the vacation balance from the process engine (140). As another example, in response to the employee initiating the process (502/202) via a pull-down menu in groupware software, the process engine (140) delivers a form to the employee's terminal (110) which already includes the vacation balance information. As another example, the process engine (140) delivers vacation balance data to the employee's terminal (110) in response to the initiation of the process (202), and software on the terminal (110) handles presentation of the vacation balance (e.g., filling-in vacation balance fields of a form with the data).

The employee enters a time period for the proposed vacation (510), and information regarding resolvable and unresolvable conflicts is presented (512), although not necessarily in any particular order. For example, some or all of the conflict information may be acquired and/or displayed before the employee enters proposed vacation dates. Further, the vacation dates may be proposed before the conflict information is acquired from the process engine (140). Further, scheduling information may be acquired before dates are received, and then highlighted or annotated after the proposed vacation dates are received.

As described above for the manager, the employee may request conflict resolution (514), requesting that a search algorithm be applied to resolve conflicts and/or by moving or rescheduling soft conflicts. The steps of requesting conflict resolution (514) and updating the conflict information (516) may be repeated several times until a solution acceptable to the employee is found.

In this embodiment, the vacation request generation process ends with the employee submitting (518/220) the vacation request to the process engine (140). The vacation request may also include comments added by the employee. Additionally, all or some of the conflict information provided by the process engine may be included with the submitted vacation request.

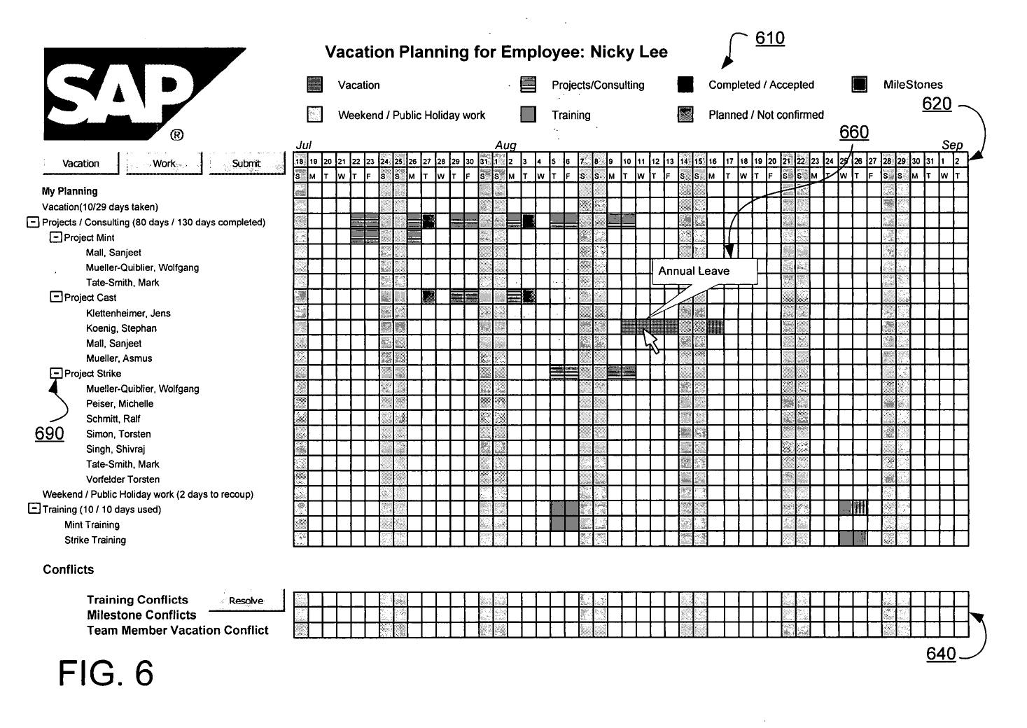

FIG. 6, is an example of the representation of data as presented to the employee in a calendar-style format allowing easy visualization. The symbols used with the date entries in this example are identified in a legend (610). Date entries are illustrated along a timeline (620), together with conflict and scheduling information (640). Additional information about each entry can be determined by way of a separate window or a pop-up (660) that appears when the entry is selected, or by providing a separate active display field/box which displays more information when the entry is selected. The various pieces of information can be expanded for viewing using “+” and “−” symbols (690) illustrated along the left side of the figure (“+” not shown, but see “495” in FIGS. 4A-4C).

Whether information about other personnel is displayed to the employee for conflict resolution may depend upon a rank (e.g., security authorization) of the employee. Scheduling information of other personnel can be used to determine conflicts even if the schedules of other personnel are hidden from the employee. If the schedules of other personnel are not displayed, an indication may be provided indicating that there is overlap with another member of a group without disclosing detailed information (for example, by pop-up).

The employee's vacation balance is included, as is the balance of the number of days completed on the projects (i.e., 80 days of 130 days completed). Buttons are included for “vacation” to enter vacation dates, “submit” to submit the vacation request for processing, and “resolve” to initiate automated conflict resolution.

Additional provision may be made for “tentative” schedule changes which are not finalized unless the vacation is approved. For example, if an alternative training date is available, the system may allow the employee to “reserve” space in the alternative training. If the vacation request is approved, the old training enrollment is cancelled and the new reservation is finalized, whereas if the request is denied, the reservation is cancelled and the employee is left enrolled in the original training.

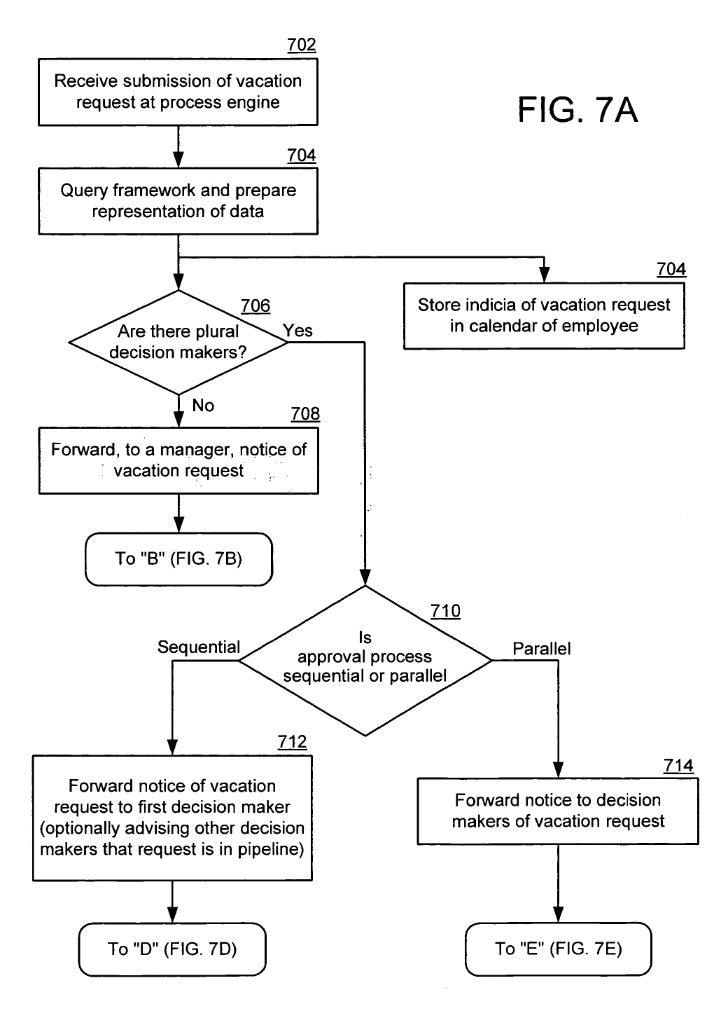

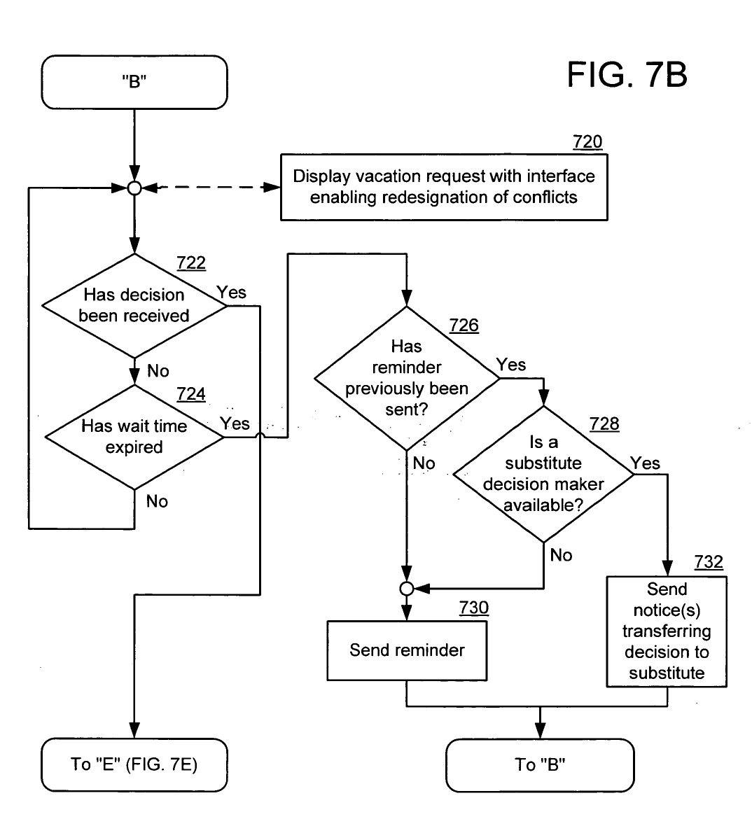

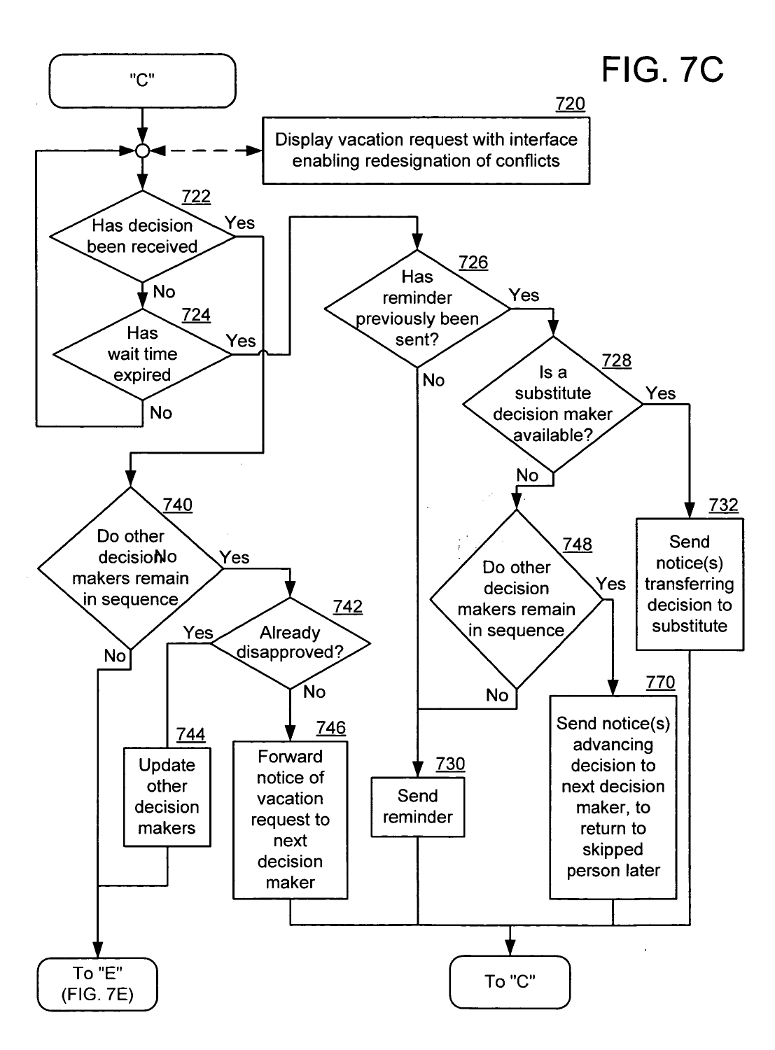

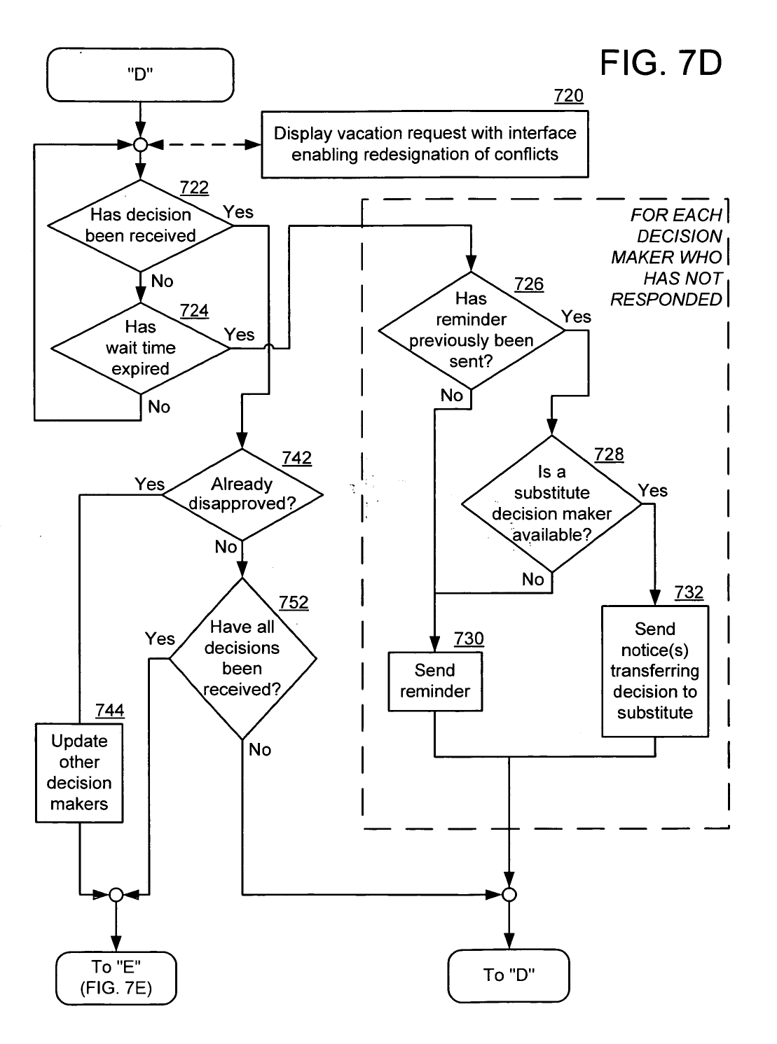

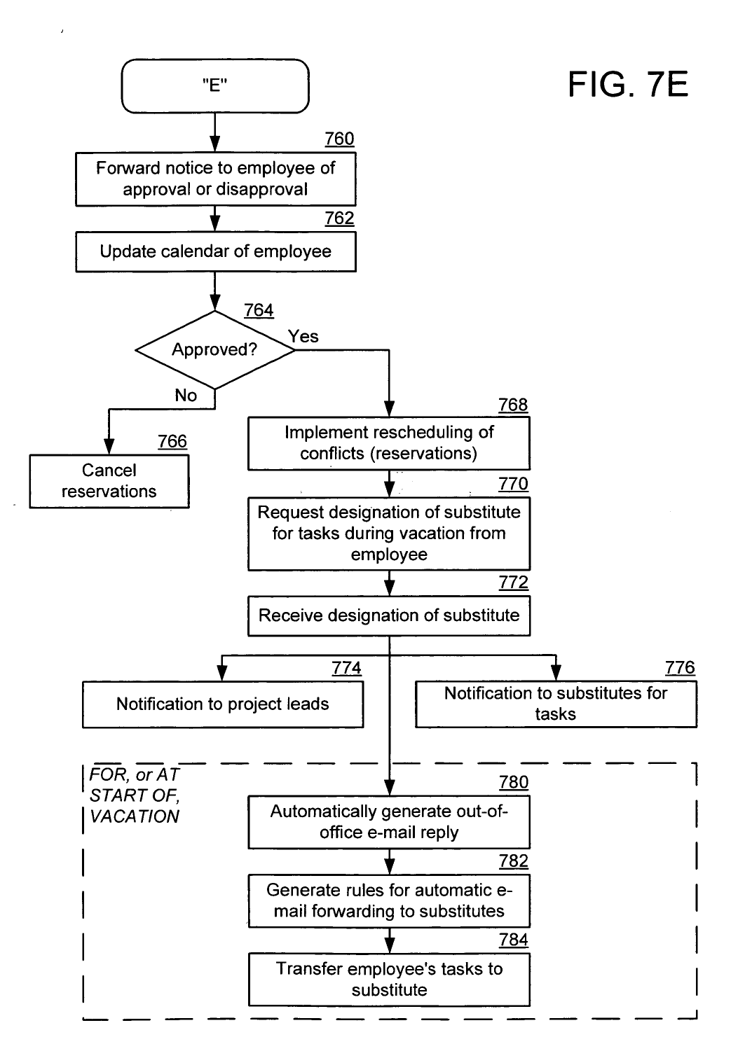

FIGS. 7A-7E are a flow chart illustrating another embodiment for handling the vacation request once it is submitted to the process engine (140). After submission to the process engine (702), indicia of the vacation request is stored (704) in the employee's groupware calendar. The employee and/or the employee's groupware calendar may receive status updates throughout the approval process.

How the approval process proceeds depends upon how many decision makers must approve the vacation request. If the process engine (140) determines (706) that only a single approval is required (e.g., by querying the human resources system 154), a notice of the vacation request is forwarded (708) to the sole decision maker (e.g., a manager). The notice may indicate that the vacation request has been received, may include all or some of the information that the decision maker will use when deciding whether to approve the request, may include a link to a web or network location, may include a form including a script which will populate fields of the form, or may include a combination thereof. The notice may be sent directly to the decision maker (e.g., personal e-mail or instant message) or delivered to a work list.

The vacation request may be displayed (720) for a manager/decision maker on his/her terminal (120), based upon query-responses and a representation of data as illustrated in FIG. 3 and utilizing a user interface like that illustrated in FIGS. 4A-4C. The manager may be provided with an interface for conflict resolution having the features described above in the other embodiments.

The process engine (140) may automatically institute proactive measures if no decision on the vacation request is received in a timely manner. For example, if no decision is received (722) and a preset wait time has passed (724), the process engine (140) may automatically take steps to expedite getting a response. The preset wait time may be a preset value or date, and may be based in part upon the proximity of the requested vacation dates. For example, if the preset value is three days, but the first day of vacation requested is in two days, the preset wait time can be adjusted accordingly. Although the wait state is illustrated as a loop, the process engine may queue/store a status check for the particular time and date, and clear the status check if a decision is received.

A first example of proactive action is sending out reminders. If a reminder has not yet been sent (726), the process engine sends out a reminder message (730) to the decision maker (e.g., e-mail or instant messaging). If a reminder (or reminders, depending upon settings and the proximity of the due date) has been previously sent (726), but no response was received, a second example of proactive action is checking (728) to see if a substitute decision maker/manager is available to consider the vacation request. An appropriate substitute may be determined based in part upon preferences, human resources data, designations, lists, etc. stored in the process engine framework. A substitute may also be designated by the decision maker. If a substitute is available, the process engine (140) may send notice of the vacation request (and the history/delay) to the substitute decision maker, and notify the original decision maker and/or withdraws the original notice (732).

Returning to FIG. 7A, in implementations where plural persons must approve the vacation request, how the process proceeds depends upon whether decision makers will review the request in parallel or sequentially (710). In either case, the content of notice(s) forwarded for plural decision makers may be similar to the notice described above for a single decision maker (708).

If the process engine (140) determines that consideration will be sequential (710), notice of the vacation request is sent (712) to the first decision maker, optionally advising the other decision makers that the request is in the decision-making pipeline.

Referring to FIG. 7C, sequential consideration encompasses the process for single manager consideration (FIG. 7B). Additionally, if a decision is received from the first decision maker, a check is made as to whether other decision makers remain in the decision sequence (740). If other decision makers remain, a check is made to determine whether the vacation request has already been declined (742). If a disapproval has been received, and the remaining decision makers had been notified that the vacation request was in the pipeline, a notice can be sent out to advise the remaining decision makers that the request was declined before reaching them (744). Notice can also be sent to earlier decision makers who approved the vacation request. If a disapproval has not been received, notice is sent to the next decision maker in the sequence (746).

Also, additional proactive actions may be included. For example, if no response was received to the notice and reminders (722, 724, 726), and no substitute decision maker is available (728), the process engine can skip the decision maker if others remain in the sequence (748). In this case notices are sent out, and the original notice may be withdrawn, as described above for transferring the decision to a substitute (732). In the alternative, a check may be made as to whether to skip a decision maker before sending a reminder and/or before determining whether a substitute is available.

Returning to FIG. 7A, if plural persons must approve the vacation request (706) and the process engine (140) determines that consideration will be concurrent (710), notice of the vacation request is sent (714) to the plural decision makers.

Referring to FIG. 7D, concurrent consideration encompasses the process for single manager consideration (FIG. 7B). Additionally, a check is made as to whether decisions have been received from all of the decision makers (752). Proactive actions (726-732) may be implemented individually for each decision maker that has not responded.

Where plural persons must approve the vacation request, the information displayed may be tailored differently for each decision maker. For example, a human resources manager may be presented with a broad view of all personnel, a project manager may only be shown information related to his/her team, and a general manager may be shown information for all teams affected.

If vacation requests are pending from two-or-more people, a decision maker may be offered a choice to simultaneously resolve the conflicts among the plural requests. For example, if multiple people requesting vacations work on the same projects, or if a person requesting vacation is designated as a possible alternate (substitute) for another person requesting vacation, the process engine may provide integrated information and conflict resolution based on the plural vacation requests.

FIG. 7E illustrates the processing of a vacation request after decisions are received by the process engine (140). The process engine (140) forwards notice to the employee of approval or disapproval (760), and updates the groupware calendar of the employee (762). If the request was not approved (764), the process engine clears scheduling reservations (766) that may have been held for the employee (e.g., alternate training reservations).

If the vacation was approved (764), the process engine automatically implements the rescheduling of reservations and tentative changes made to avoid conflicts (768). A request is sent to the employee asking the employee to designate substitutes for tasks during the vacation (770), if not already indicated during the planning and approval process. Once a designation of substitute(s) is received (772), notification is sent to project leaders (774) and to the substitutes designated for the respective tasks (776).

Either before or at the start of the vacation, the process engine automatically generates and sets an out-of-office e-mail reply for the employee (780), generates rules for automatically forwarding e-mails to the designated substitutes (782), and transfers the employee's tasks to the designated substitutes (784). Likewise, when the employee returns, the. process engine can automatically turn-off the auto-reply and the forwarding rules, and restore the tasks back to the employee.

As mentioned above, some or all of the information provided to the employee may be included in the information forwarded to decision makers. While the embodiments above include multiple interactions with the process engine, it is contemplated that some of the same functionality may be obtained with minimal interaction.

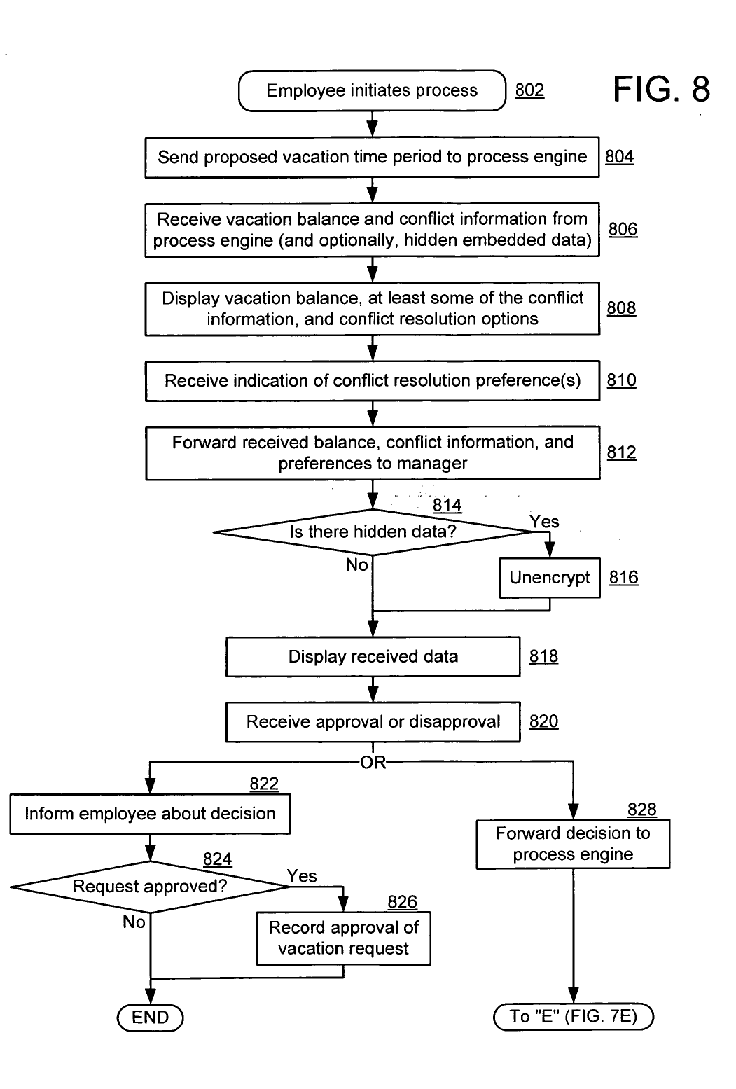

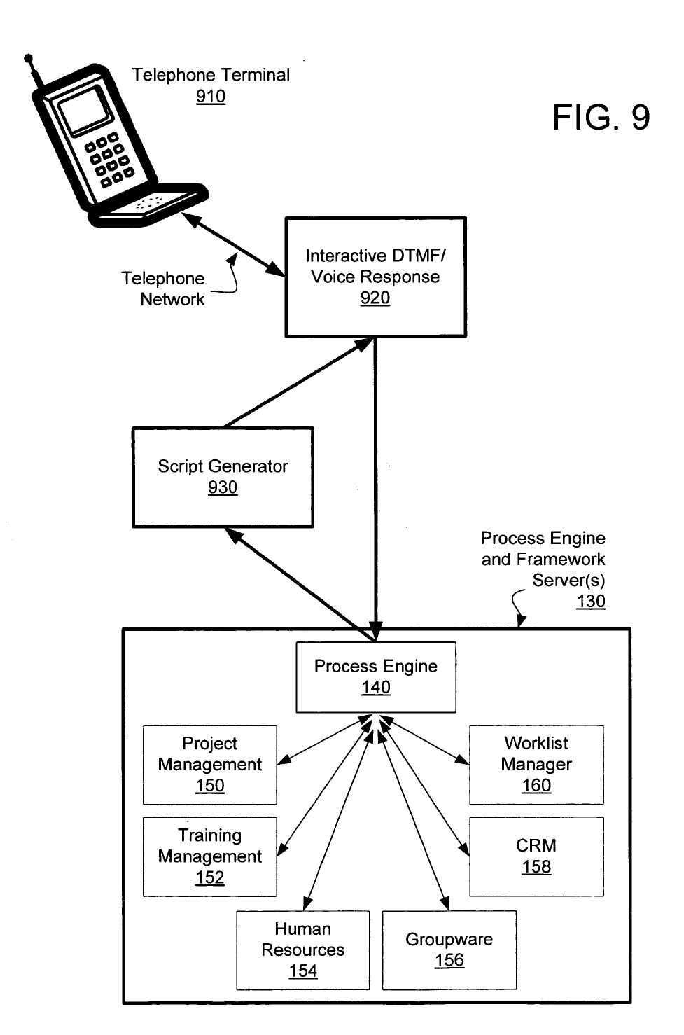

FIG. 8 is an example of a more process-engine independent embodiment. The employee initiates the process (802) and a proposed vacation time period is sent to the process engine (804). The process engine responds with conflict data to the employee's terminal for generation of the vacation request (806). The employee's vacation balance, and at least some of the conflict information and conflict resolution options described in the other embodiments are displayed (808) on the employee's terminal (110).

Several mechanisms may be used for the display of the information and options. For example, software resident on the employee's terminal may render the information sent by the process engine for the employee. Such software may be an enhancement to a personal information and communication package or a groupware package.

After the employee indicates conflict-resolution preferences (810), the information and preferences are forwarded to a manager (812). While the display mechanisms discussed for the earlier embodiments are applicable here, a distinction is that the vacation request is sent directly to the manager or a manager's work list rather than back to the process engine. Either the employee may choose where the vacation request is sent or the process engine may include the destination(s) with the original information (806) so that the employee simply chooses to submit the vacation request and the destination is automatic.

Since the vacation request in this embodiment is passed from the employee to the manager without returning to the process engine (140), the information received (806) from the process engine may include data that is not displayed to the employee but will be displayed to the manager. In particular, the original data may include hidden information. If the information is sensitive, it may be encrypted. If there is hidden data (814) when received by at the manager's terminal (120), the data is unhidden and/or unencrypted (816).

The manager's terminal (120) displays the vacation request for the manager's approval or disapproval (820). The vacation request may be displayed utilizing one of the display mechanisms described above, thereby permitting the manager to also provide scheduling and conflict resolution changes or redesignations, like those described in the earlier embodiments.

If plural decision makers must sequentially approve the vacation request, the vacation request may be forwarded to the next decision maker. The next decision maker may be specified by the manager, or may be designated in information embedded in the original data provided to the employee by the process engine.

Without further involvement of the process engine, notice of the manager's decision may be sent to the employee (822), and if the request was approved (824), a record of the approval is made (826). As an alternative, the final decision can be reintegrated into the process engine framework after the decision is finalized. For example, the decision may be forwarded (828) to the process engine for processing (“E” in FIG. 7E).

Another option, particularly if there is a single decision maker or if there are plural decision makers deciding in parallel, is to utilize the proactive action features of the process engine. In this case, decisions are forwarded (828) to the process engine enter the process of the earlier embodiments at a point such as from receipt of the decision (722) in FIGS. 7B or 7D.

As a further embodiment of the invention, telephone-based access to the process engine (140) may be provided, as illustrated in FIG. 11. For telephone-based access, a telephone terminal (910) dials into interactive voice response (IVR) system (920). As is known in the art, in addition to caller speech, the IVR system (920) may also respond to touch-tone (DTMF) instructions from the telephone terminal (910). Telephone-based access may be used to create the vacation request, to designate substitutes, and/or (by one or more decision makers) to approve or decline the request. Further, a user may request that notifications be provided by telephone, in which case the process engine (140) may arrange a call between the IVR system (or other speech-generation system) and the user.

Guided procedures, as described above, are easily adapted for a speech-based user interface. A script generator (930) may be used to convert the forms, options, guided procedure and other information into a script for the IVR system (920). However, the script generator is not necessarily required, depending on the format of forms generated by the process engine and the capabilities and sophistication of the IVR system. For example, IVR systems are commercially available that directly process XML documents.

Moreover, in view of the blending of computers and telephony, it is contemplated that both the IVR system (920) speech-based interface and a computer-oriented display-based interface may be used simultaneously by the same terminal.

As described above, vacation planning and approval, according to embodiments of the present invention, are no longer a pure booking and confirmation process. All involved parties receive relevant data generated and presented during the decision making process. Conflict Resolution functions support both the employee and the decision maker in re-scheduling events without requiring contact with other persons. Project plans can be easily adjusted, as changes made during the approval process are automatically updated in project management systems.

While the flow charts of the various embodiments illustrate the choices and actions in a particular order, it should be recognized that the order of choices and actions can be changed while achieving the same or substantially the same results.

While the process engine application (140) may be an application running on a server or servers, it may of course be running on a terminal, including the terminals of an employee (110) and/or a manager (120). Portions or an entirety of the framework (150-160) utilized by the process engine (140) may also be local. The process engine may be a stand-alone application, a component of a suite, an executable script (e.g., Visual Basic®, Java™), or may be an enhancement to another application.

While the embodiments describe the invention in the context of vacation planning, the invention is also applicable to the scheduling of other events which involve a scheduling and approval process.

The terminals (110, 120, 910), server or servers (130), voice response system (920), and script generator (930) may each include a storage component for storing machine-readable instructions for performing the various processes of the embodiments. The storage component may be any type of machine readable medium (i.e., one capable of being read by a machine) such as a compact disk, hard drive memory, flash memory, floppy disk memory, DVD-ROM, CD-ROM or any type of machine readable (computer readable) storing medium. Each may also include addressable memory (e.g., random access memory, cache memory) to store data and/or sets of instructions that may be included within, or be generated by, the machine-readable instructions when they are executed by a processor on the respective platform.

Several embodiments of the invention are specifically illustrated and/or described herein. However, it will be appreciated that modifications and variations of the invention are covered by the above teachings and within the purview of the appended claims without departing from the spirit and intended scope of the invention.

1. A method for vacation scheduling and approval comprising:
responsive to a vacation request from an employee including a time period for a proposed vacation, extracting a number of vacation days taken by the employee from an employee data record and accessing at least one database to extract scheduling data for at least the time period of the proposed vacation;
comparing the scheduling data with the time period for the proposed vacation to determine potential conflicts;
conveying the time period for the proposed vacation, the number of vacation days taken by the employee, and the potential conflicts to a decision maker; and
transmitting notice to the employee of approval or disapproval by the decision maker.

2. The method according to claim 1, further comprising:
responsive to receiving from a first terminal an indication that the vacation request is to be generated and an identifier for the employee, extracting a vacation balance for the employee from the employee data record; and
transmitting the vacation balance for the employee to the first terminal.

3. The method according to claim 2, further comprising:
generating the vacation request at the first terminal, comprising:
outputting the vacation balance at the first terminal;
receiving the time period for the proposed vacation; and
submitting the vacation request including the time period for the proposed vacation.

4. The method according to claim 3, wherein a groupware client on the first terminal provides a user interface for said generating the vacation request.

5. The method according to claim 3, further comprising:
responsive to receiving from the first terminal an indication that the vacation request is to be prepared and the employee identifier, accessing at least one database to extract scheduling data associated the employee identifier;
generating an interactive form comprising the scheduling data, the interactive form including at least one field to receive the time period for the proposed vacation; and
conveying the form to the first terminal.

6. The method according to claim 3, the method further comprising:
responsive to receiving the time period for a proposed vacation from the first terminal, accessing at least one database to extract scheduling data for at least the time period of the proposed vacation;
comparing the scheduling data with the time period for the proposed vacation to determine potential conflicts; and
conveying the potential conflicts to the first terminal, and
said generating the vacation request at the first terminal further comprising:
outputting the potential conflicts; and
providing a user interface for resolving at least some of the potential conflicts.

7. The method according to claim 1, further comprising:
responsive to the vacation request from the employee including the time period for the proposed vacation, automatically storing indicia of the vacation request in a groupware calendar of the employee; and
responsive to approval or disapproval for the proposed vacation from the decision maker, automatically updating a status of the vacation request included with the stored indicia of the vacation request.

8. The method according to claim 1, further comprising:
responsive to approval of the proposed vacation from the decision maker, automatically setting an e-mail auto-reply for the employee for the time period of the approved vacation.

9. The method according to claim 1, further comprising:
responsive to approval of the proposed vacation from the decision maker, automatically requesting designation of a substitute from the employee.

10. The method according to claim 9, further comprising:
responsive to designation of the substitute from the employee, automatically transferring groupware tasks of the employee to the designated substitute for the time period of the approved vacation.

11. The method according to claim 1, said accessing at least one database to extract scheduling data comprising:
accessing a data record to extract identifiers for projects associated with an identifier of the employee; and
accessing a data record to extract project scheduling data associated with the project identifiers, and
said comparing the scheduling data with the time period for the proposed vacation to determine potential conflicts comprising:
comparing the project scheduling data with the time period of the proposed vacation to determine project scheduling conflicts,
wherein the potential conflicts conveyed to the decision maker further include a breakdown of the project scheduling conflicts by project.

12. The method according to claim 11, said accessing at least one database to extract scheduling data further comprising:
responsive to extracting identifiers for projects associated with the identifier of the employee, accessing a data record to extract identifiers for other personnel assigned to each project; and
accessing at least one database to extract scheduling data associated with each of the identifiers for the other personnel for at least the time period of the proposed vacation, and
said comparing the scheduling data with the time period for the proposed vacation to determine potential conflicts further comprising:
comparing the scheduling data for the other personnel with the time period for the proposed vacation to determine scheduling conflicts;
wherein the potential conflicts conveyed to the decision maker further include scheduling conflicts with the other personnel.

13. The method according to claim 12, wherein said accessing at least one database to extract scheduling data associated with each of the identifiers for the other personnel includes extraction of proposed vacation data and approved vacation data for each of the other personnel, and further comprises:
responsive to extracting identifiers for the other personnel, for each of the other personnel, extracting total vacation days available and total vacation days taken from a data record,
the method further comprising conveying the proposed vacation data, the approved vacation data, the total vacation days available, and the total vacation days taken for each of the other personnel to the decision maker, identifying the projects with which each of the other personnel is associated.

14. The method according to claim 1, further comprising:
outputting for the decision maker at a second terminal, the time period for the proposed vacation, the number of vacation days taken by the employee, and the potential conflicts; and
providing, at the second terminal, a user interface for resolving at least some of the potential conflicts.

15. The method according to claim 1, wherein responsive to a vacation request from an employee including a time period for a proposed vacation, transmitting a notice of the vacation request to the decision maker, the notice conveying the time period for the proposed vacation, the number of vacation days taken by the employee, and the potential conflicts are conveyed to the decision maker.

16. The method according to claim 1, further comprising conveying taken and open vacation days per employee to the decision maker.

17. A machine-readable medium storing instructions adapted to be executed by a processor to perform a method comprising:
responsive to a vacation request from an employee including a time period for a proposed vacation, extracting a number of vacation days taken by the employee from an employee data record and accessing at least one database to extract scheduling data for at least the time period of the proposed vacation;
comparing the scheduling data with the time period for the proposed vacation to determine potential conflicts;
conveying the time period for the proposed vacation, the number of vacation days taken by the employee, and the potential conflicts to a decision maker; and
transmitting notice to the employee of approval or disapproval by the decision maker.

18. The machine-readable medium according to claim 17, wherein the instructions to convey information including the time period for the proposed vacation, the number of vacation days taken by the employee, and the potential conflicts to the decision maker are to transmit the information to a groupware account of the decision maker.

19. The machine-readable medium according to claim 17, wherein the instructions to convey information including the time period for the proposed vacation, the number of vacation days taken by the employee, and the potential conflicts to the decision maker are to post the information to a worklist accessible to the decision maker.

20. The machine-readable medium according to claim 17, the method further comprising:
responsive to receiving an indication that the vacation request is to be generated and an identifier for the employee from a first terminal, extracting a vacation balance from the employee data record; and
transmitting the vacation balance for the employee to the first terminal.

21. The machine-readable medium according to claim 20, the method further comprising:
responsive to receiving an indication that the vacation request is to be prepared and the employee identifier from the first terminal, accessing at least one database to extract scheduling data associated the employee identifier;
generating an interactive form comprising the scheduling data, the interactive form including at least one field to receive the time period for the proposed vacation; and
conveying the form to the first terminal.

22. The machine-readable medium according to claim 20, the method further comprising:
responsive to receiving the time period for the proposed vacation from the first terminal, accessing at least one database to extract scheduling data for at least the time period of the proposed vacation;
comparing the scheduling data with the time period for the proposed vacation to determine potential conflicts;
conveying the potential conflicts to the first terminal.

23. The machine-readable medium according to claim 17, the method further comprising:
responsive to the vacation request from the employee including the time period for the proposed vacation, automatically storing indicia of the vacation request in a groupware calendar of the employee; and
responsive to approval or disapproval for the proposed vacation from the decision maker, automatically updating a status of the vacation request included with the stored indicia of the vacation request.

24. The machine-readable medium according to claim 17, the method further comprising:
responsive to approval of the proposed vacation from the decision maker, automatically setting an e-mail auto-reply for the employee for the time period of the approved vacation.

25. The machine-readable medium according to claim 17, the method further comprising:
responsive to approval of the proposed vacation from the decision maker, automatically requesting designation of a substitute from the employee.

26. The machine-readable medium according to claim 25, the method further comprising:
responsive to designation of the substitute from the employee, automatically transferring groupware tasks of the employee to the designated substitute for the time period of the approved vacation.

27. The machine-readable medium according to claim 17, said accessing at least one database to extract scheduling data comprising:
accessing a data record to extract identifiers for projects associated with an identifier of the employee; and
accessing a data record to extract project scheduling data associated with the project identifiers, and
said comparing the scheduling data with the time period for the proposed vacation to determine potential conflicts comprising:
comparing the project scheduling data with the time period of the proposed vacation to determine project scheduling conflicts,
wherein the potential conflicts conveyed to the decision maker further include a breakdown of the project scheduling conflicts by project.

28. The machine-readable medium according to claim 27, said accessing at least one database to extract scheduling data further comprising:
responsive to extracting identifiers for projects associated with the identifier of the employee, accessing a data record to extract identifiers for other personnel assigned to each project; and
accessing at least one database to extract scheduling data associated with each of the identifiers for the other personnel for at least the time period of the proposed vacation, and
said comparing the scheduling data with the time period of the proposed vacation to determine potential conflicts further comprising:
comparing the scheduling data for the other personnel with the time period for the proposed vacation to determine scheduling conflicts;
wherein the potential conflicts conveyed to the decision maker include scheduling conflicts with the other personnel.

29. The machine-readable medium according to claim 28, wherein said accessing at least one database to extract scheduling data associated with each of the identifiers for the other personnel includes extraction of proposed vacation data and approved vacation data for each of the other personnel, and further comprises:
responsive to extracting identifiers for the other personnel, for each of the other personnel, extracting total vacation days available and total vacation days taken from a data record,
the method further comprising conveying the proposed vacation data, the approved vacation data, the total vacation days available, and the total vacation days taken for each of the other personnel to the decision maker, identifying the projects with which each of the other personnel is associated.

30. The machine-readable medium according to claim 17, further comprising:
conveying, to the decision maker, taken and open vacation days per employee.
